(19) United States
(12) Patent Application Publication
(10) Pub. No.: US 2017/0197551 A1
(43) Pub. Date: Jul. 13, 2017

(54) SYSTEM AND METHOD FOR COLLISION WARNING

(71) Applicant: Harman Becker Automotive Systems GmbH, Karlsbad (DE)

(72) Inventor: Kuo-Sek Lee, Munich (DE)

(21) Appl. No.: 15/398,645

(22) Filed: Jan. 4, 2017

(30) Foreign Application Priority Data
Jan. 8, 2016 (EP) 16150537

(51) Int. Cl. B60Q 9/00; G08G 1/16

(52) U.S. Cl. CPC B60Q 9/008; G08G 1/166

(57) ABSTRACT

A method for collision warning is provided comprising determining the presence of a second vehicle, driving behind a first vehicle in the same direction. A danger value is determined, which is indicative of a potential collision of the first and the second vehicle. A warning signal is generated, which is displayed in a side or rear-view mirror of the first vehicle, if the danger value crosses a predetermined threshold.

### CROSS REFERENCE TO RELATED APPLICATIONS

The present application claims priority to European Patent Application No. EP 16150537, entitled “SYSTEM AND METHOD FOR COLLISION WARNING,” and filed on Jan. 8, 2016, the entire contents of which are hereby incorporated by reference for all purposes.

### TECHNICAL FIELD

The disclosure relates to a system and a method for collision warning, in particular for rear-side collision warning and prevention in vehicles.

### BACKGROUND

For vehicle drivers it is often difficult to see another vehicle approaching from the rear and to estimate its speed, especially if the approaching vehicle is driving at high speed. The estimation of speeds for vehicles approaching from the rear may be hindered by C-pillar width, height, and location together with the shape of rear side windows. In some vehicles, high seatbacks may obstruct the vision to the rear either through the rear side window or by the rear-view mirror. But even if the driver sees another vehicle clearly in the mirrors, it is often difficult to estimate its speed correctly. This may result in a great number of accidents.

### SUMMARY

The method described herein includes the following procedures: determining the presence of a second vehicle, driving behind a first vehicle in the same direction; determining a danger value which is indicative of a potential collision of the first and the second vehicle; and generating a warning signal which is displayed in a side or rear-view mirror of the first vehicle, if the danger value crosses a predetermined threshold.

A collision warning system comprises: a detection unit, which is configured to determine the presence of a second vehicle, driving behind a first vehicle in the same direction; a controller, which is configured to determine a danger value which is indicative of a potential collision of the first and the second vehicle; and a signal unit, which is configured to generate a warning signal which is displayed in a side or rear-view mirror of the first vehicle, if the danger value crosses a predetermined threshold.

Other systems, methods, features and advantages will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The method may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 is a block diagram of an exemplary collision warning system.

FIG. 2 is a schematic diagram of a common traffic situation.

FIG. 3 is a schematic diagram of an exemplary warning signal in a rear-view mirror.

FIG. 4 is a schematic diagram of a further warning signal.

FIG. 5 is a schematic diagram of an exemplary warning signal in a side mirror.

FIG. 6 is a schematic diagram, illustrating a driver's line of vision.

FIG. 7 is a further schematic diagram, illustrating a driver's line of vision.

FIG. 8 is a flowchart of an exemplary method for collision warning.

FIG. 9 shows a block diagram of an example in-vehicle computing system.

### DETAILED DESCRIPTION

For the driver of a vehicle it is often difficult to estimate the speed of other vehicles. Especially when approaching from the rear, the speed of other vehicles is often underestimated. When seen through the rear-view or side mirrors, other vehicles often appear to be slower than they actually are. Especially at night or under bad weather conditions when sight is limited, a correct speed estimation may be difficult.

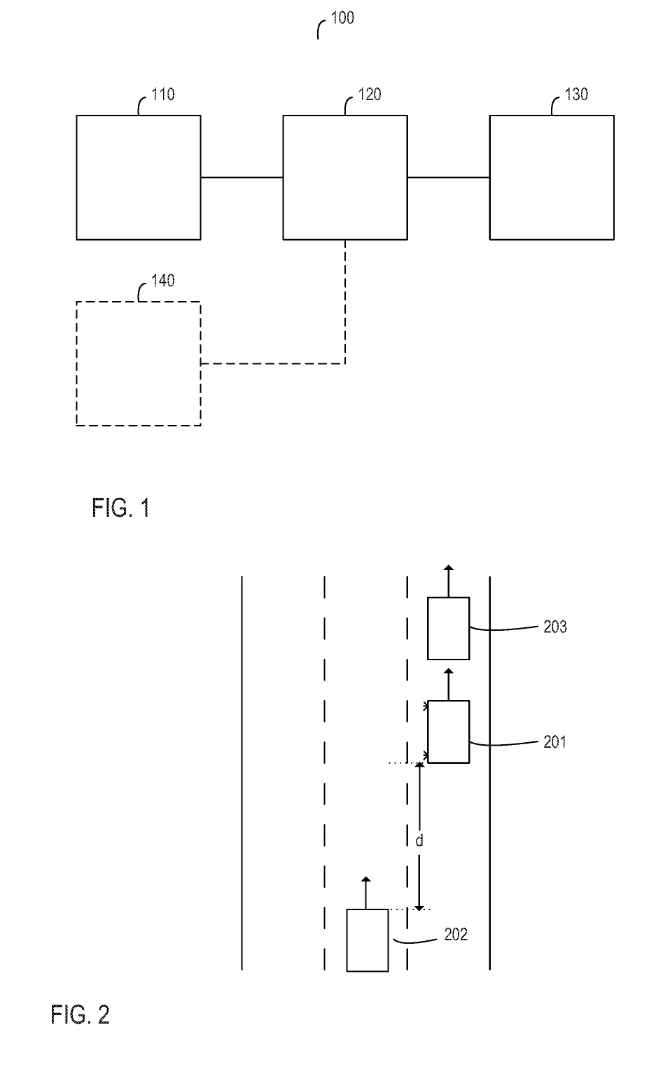

Referring to FIG. 1, a collision warning system 100 includes a detection unit 110. The detection unit 110 may be mounted on a first vehicle and is configured to detect the presence of other vehicles driving behind the first vehicle. The detection unit 110 may be mounted on the rear or on the side of a vehicle, for example. It may be mounted at any position on the vehicle, from where it is able to detect at least one of the presence, the direction of movement and the speed of another vehicle, for example. The vehicles may be cars, trucks, motorcycles or any other kind of vehicles. The presence of another vehicle may be determined using object recognition and direction of movement detection techniques. Methods are known with which objects, such as vehicles, may be identified in an image or a video sequence. The detection unit 110, therefore, may include one or more cameras, for example. Other object recognition methods include laser based, ultrasound based or radar based methods. To estimate the direction of movement of a vehicle, vector algorithms may be used, for example. Other vehicles may drive at a constant distance behind the first vehicle, may approach the first vehicle from the rear or may recede from the first vehicle. Another vehicle may drive behind the first vehicle on the same lane. It is, however, also possible to detect other vehicles, which are driving on another lane of a multi-lane road, if the detection range of the detection unit 110 not only includes the area behind the first vehicle, but also lateral areas.

The detection unit 110 may further be configured to estimate the speed of a detected vehicle. Approaching vehicles and their speed may be detected by means of an appropriate sensor. Such sensor may, for example, be laser based. One example of a laser based sensor is the so-called laser surface velocimeter (LSV). An LSV is a non-contact optical speed sensor, which is configured to measure the speed of moving surfaces. LSVs use the laser Doppler principle to evaluate the laser light scattered back from a moving surface. The Doppler effect (or Doppler shift) is the change in frequency of a wave for an observer moving relative to the source of the wave. LSVs are widely known and, therefore, will not be explained in further detail.

A laser based sensor, however, is also only an example. Other sensors may be used as well. For example, the speed of an approaching vehicle may be determined using a radar based sensor, like a Doppler radar. A Doppler radar is a specialized radar that uses the Doppler effect to produce velocity data about objects at a distance. A microwave signal is bounced off a desired target and it will then be analyzed how the object's motion has altered the frequency of the returned signal. This variation gives direct and highly accurate measurements of the radial component of a target's velocity relative to the radar. The sensors described above, however, are only examples. Any other suitable object recognition and speed sensors may be used as well.

The detection unit 110 may further be configured to estimate the distance between the first vehicle and a second vehicle. The distance between the vehicles may also be detected by means of laser, radar or ultrasound sensors, for example.

The detection unit 110 may be mounted to the rear of the first vehicle. For example, it may be mounted to the center high mount stop light (CHMSL). This is, however, only an example. The detection unit 110 may be mounted on the first vehicle at any suitable position from where it is able to scan the area behind the first vehicle.

Vehicles may be detected when the distance between the vehicles is less than a predetermined distance. The distance from which a vehicle may be detected, among other things, depends on the kind of sensor that is used. For example, vehicles may be detected when the distance to the first vehicle is less than 250 m, if a laser sensor is used.

Information about a detected vehicle and/or the speed of a detected vehicle may be periodically sent to a controller 120, which is coupled to the detection unit 110. The controller 120 may further process the data and determine a danger value. The danger value may be dependent on a changing distance between the first vehicle and the second vehicle. The controller 120 may, however, consider further parameters, such as the speed of the first and/or the second vehicle, the presence of further vehicles, road conditions, a steering angle of the first vehicle, a gear position, a turn indication (indicators activated/not activated) and/or a route that has been entered in the first vehicles navigation system. Any other parameters may be considered as well. If the danger value determined by the controller 120 crosses a predefined threshold, a warning signal will be generated. The danger value may be determined by any suitable algorithm. In the simplest case, for example, the danger value only has two conditions, a logical “1” (high state) and a logical “0” (low state). The danger value may be 0, if no vehicle is detected, and may be 1 if a vehicle is detected. If the threshold is chosen between 0 and 1, a warning signal will be generated as soon as another vehicle is detected.

Other examples are illustrated in the following. The driver, for example, may be informed about a second vehicle, if the distance between the first and the second vehicle is less than a predetermined distance. It may further be taken into consideration, whether the second vehicle is considerably faster than the first vehicle and is therefore approaching the first vehicle. If the second vehicle is slower than the first vehicle and is receding, it might not be necessary to inform the driver, for example. Further, it might not be necessary to generate a warning signal, if the driver of the first vehicle does not make any preparations for overtaking any other vehicles.

Referring to FIG. 2, a first vehicle 201 is driving on the very right lane of a three-lane road. The vehicles in this example are left-hand driven vehicles and an overtaking maneuver generally takes place on the left side. A second vehicle 202 approaches on the middle lane from the rear. A third vehicle 203 is driving in front of the first vehicle 201 on the very right lane. The second vehicle 202 may be detected, once it falls below a certain distance d from the first vehicle 201. When the second vehicle 202 is detected, the driver of the first vehicle 201 may be informed about the approaching vehicle. However, it may not be necessary to inform the driver at any rate. For example, the driver of the first vehicle 201 may only be informed, when he wishes to overtake the third vehicle 203 (and when the danger value crosses the predetermined threshold). This may be detected, when the driver activates the indicator to initiate a passing maneuver. It is, for example, also possible to detect a passing maneuver when it is detected that the vehicle moves to a different lane. Lane departure warning systems today are able to detect a change of lanes, for example. The driver, therefore, may only be informed about the second vehicle 202, when the distance d between the vehicles is shorter than a predetermined distance and the indicator is activated. This is, however, only an example. Any other parameters may be taken into consideration for a decision, whether a warning signal should be generated or not. The above has been described for right-hand traffic. The same, however, applies for left-hand traffic, where the overtaking maneuver takes place on the right side.

Again referring to FIG. 1, the collision warning system 100 further includes a signal unit 130. The signal unit 130 may be configured to generate the warning signal. The warning signal may be an acoustical or a visual warning signal. An acoustical signal could be a single tone, a tone sequence or an announcement, for example. As a visual warning signal, a caution light may be turned on or may begin to flash. It is also possible to display any kind of warning signal on a display, e.g. the display of a built-in navigation system.

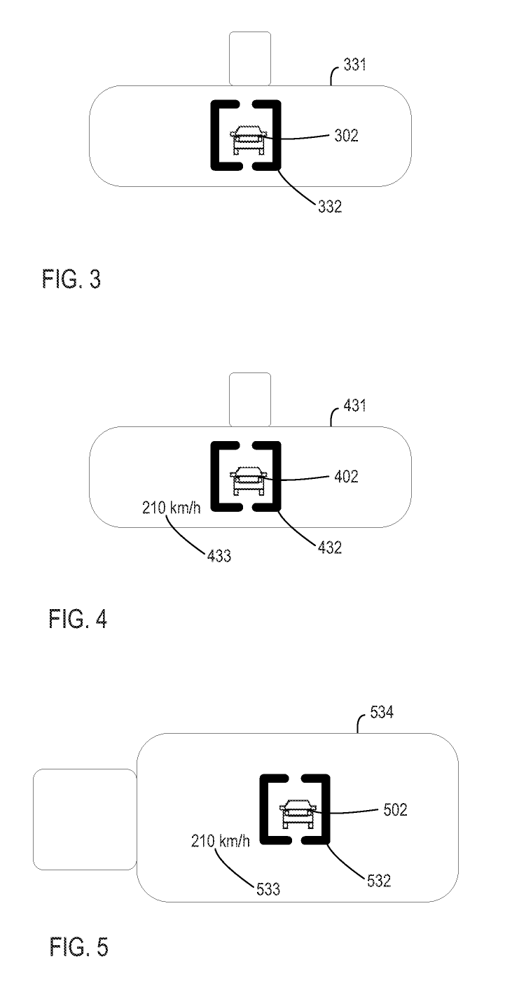

Referring to FIG. 3, the warning signal 332 is displayed in the rear-view mirror 331 of the first vehicle. When the second vehicle 302 appears in the rear-view mirror 331, an edging may be faded-in, which surrounds the reflection of the second vehicle 302. The edging may have a square, rectangular or round shape, for example. Any other shapes, however, are also possible. Alternatively, it is further possible to just underline the reflection of the second vehicle 302 or highlight the reflection in any other way.

A warning signal may be generated each time a vehicle is detected and shows a reflection in at least one of the side or rear-view mirrors. This may, however, be disturbing for the driver of the first vehicle and/or the driver might get used to the warning signal. If, for example, a warning signal 332 is not generated each time a vehicle's reflection appears in the rear-view mirror 331, but only when a collision is likely to happen, the driver will not get used to the warning signal and will be encouraged to evaluate the situation more carefully.

Optionally or additionally to just highlighting another vehicle 402 in the rear-view mirror 431, the signal unit 130 may be configured to display a textual (or text-based) warning in the mirror 431. The text-based warning may be, as non-limiting examples, “caution”, “stop” or “brake”. The textual warning may also include the determined speed 433 of the other vehicle 402. This is schematically illustrated in FIG. 4. In this case, the driver of the first car does not need to estimate the speed of the second vehicle 402 anymore, but is provided with a substantially precise value. This makes it easier for the driver to evaluate a situation and, for example, make a decision whether to overtake a third vehicle in front or wait until the second car 402 has passed.

Referring to FIG. 5, the warning signal 532 and/or speed indication 533 (or other writing) may additionally or optionally be displayed in one or both of the side mirrors 534. Some drivers only take a look in the rear-view mirror 331, 431 or only in the side mirrors 534. If a warning signal 332, 432, 532 and/or speed indication 433, 533 is displayed in both the rear-view mirror 331, 431 and the side mirrors 534, the chances are higher that the driver notices the warning signal.

Additionally or optionally to generating a warning signal, the signal unit 130 may be configured to support the driver when conducting any maneuvers, in order to avoid collisions. In order to determine the danger value, relevant parameters may be taken into consideration. If the danger value and, therefore, the probability for a collision crosses a certain threshold, the signal unit 130 may assist the driver in his driving process. If, for example, a second car is approaching the first car from the rear at a high speed and the driver of the first car, which is travelling at a significantly lower speed, initiates a passing maneuver, the signal unit 130 may intervene. For example, the signal unit 130 may make sure that the first vehicle stays on the current lane and may not overtake another vehicle, as long as the second vehicle is rated as a potential danger. The signal unit 130, therefore, may implement features of a lane keeping assistant or may be coupled to an available lane keeping assistant, for example.

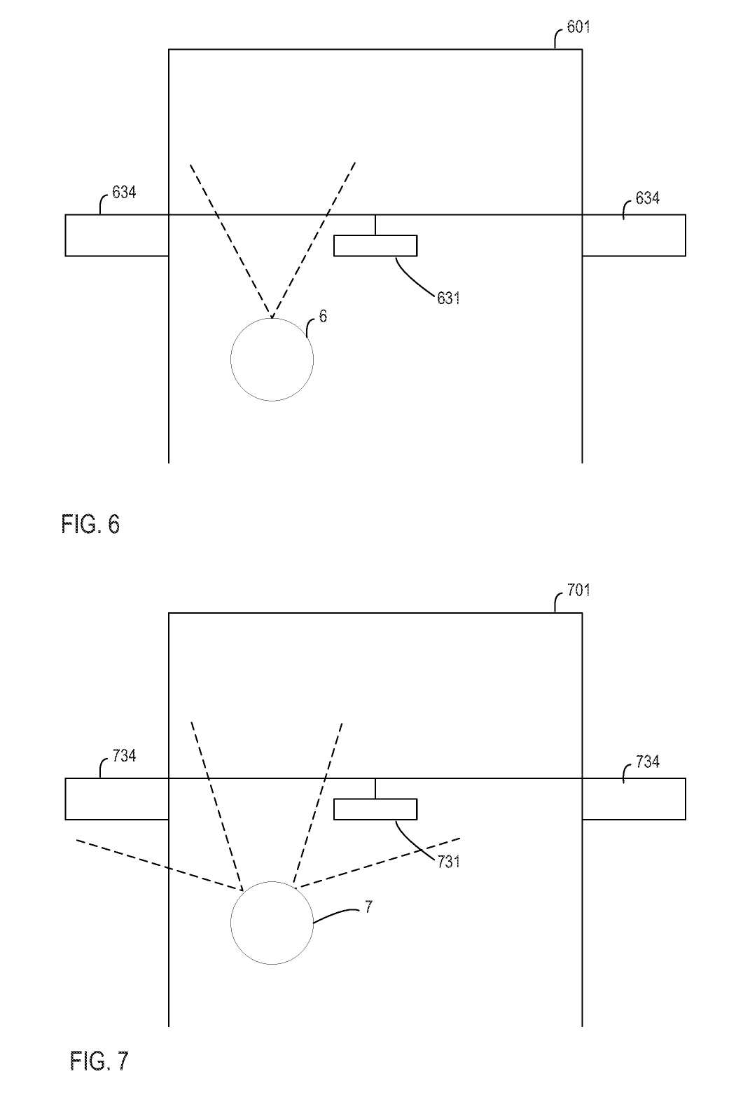

Further referring to FIG. 1, the collision warning system 100 may optionally further include a monitoring unit 140. The monitoring unit 140 is configured to monitor the line of vision of the driver 6 of the first vehicle 601. In some cases, it may be disturbing for the driver 6, when suddenly a warning signal is generated in the mirrors, which the driver 6 only recognizes from the corner of the eye when looking on the street ahead of the vehicle 601. This situation is exemplary illustrated in FIG. 6, by means of a top view of the first vehicle 601. The driver is looking straight ahead and has his sight directed on the road and other vehicles travelling in front of the first vehicle 601. In such a case the driver 6 may be disturbed, if a warning signal is generated in one of the mirrors 631, 634, as he will only see the warning signal from the corner of his eyes.

The monitoring unit 140 is configured to detect, whether the driver 7 is looking in the direction of one of the side or rear-view mirrors 731, 734, as is illustrated in FIG. 7. The monitoring unit 140 may, therefore, include a camera or any other suitable device which may detect the line of vision of the driver 7. If the monitoring unit 140 detects that the driver 7 is looking in the direction of one of the mirrors 731, 734, the warning signal may be displayed in the mirror. Otherwise, if the driver 7 is not looking in the direction of one of the mirrors 731, 734, no warning signal will be displayed in the mirror to avoid any unnecessary disturbances of the driver 7.

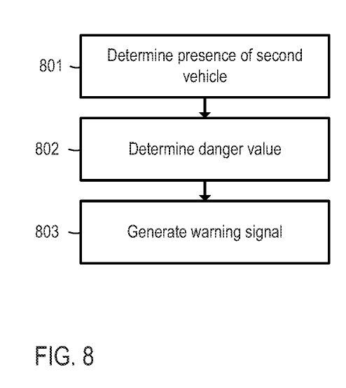

Referring to FIG. 8, a method for collision warning is illustrated. In a first step, the presence of a second vehicle, which is driving behind the first vehicle, is determined (step 801). Furthermore, a danger value is determined (step 802). The danger value is indicative of a potential collision of the first and the second vehicle. The danger value is then compared to a predetermined threshold (step 803). If the danger value crosses the predetermined threshold, a warning signal is generated. The warning signal is displayed in a side or rear-view mirror of the first vehicle (step 804) to inform the driver of the first vehicle about the presence of the second vehicle and/or to warn him about a potential collision.

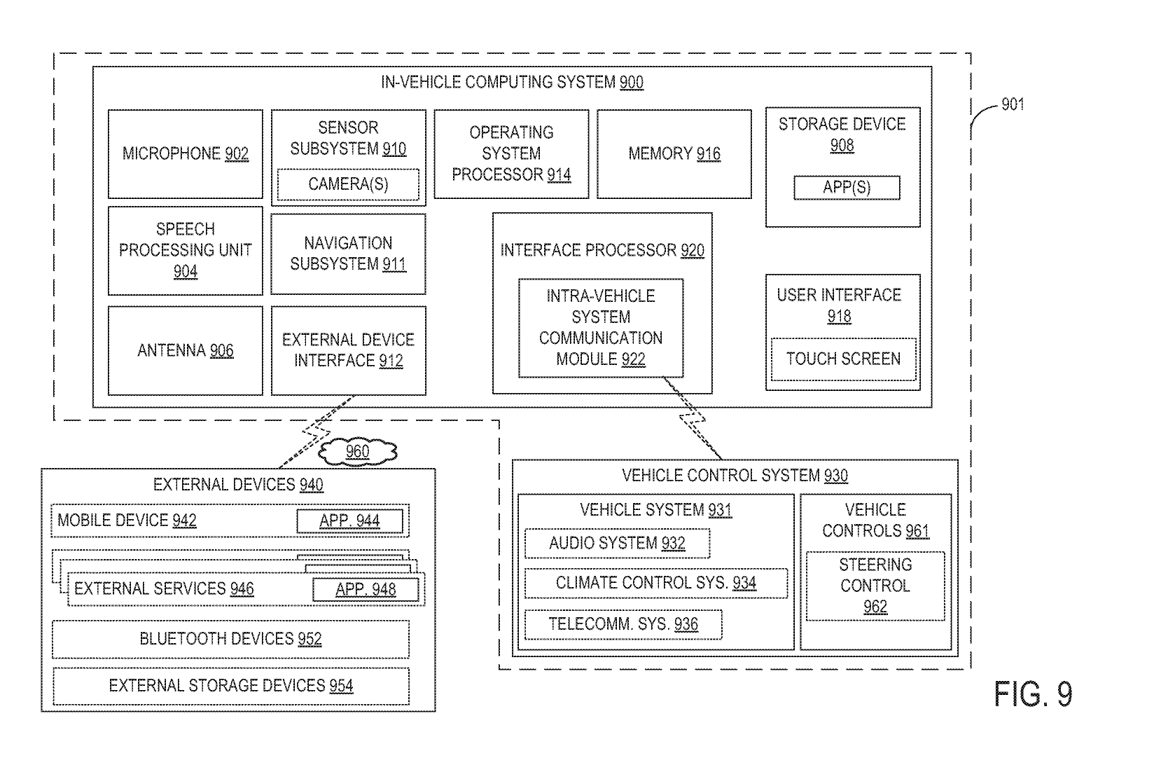

FIG. 9 shows a block diagram of an example in-vehicle computing system 900 configured and/or integrated inside a vehicle 901. Vehicle 901 may be an example of vehicle 601 of FIG. 6 and/or vehicle 701 of FIG. 7 in some embodiments. In-vehicle computing system 900 may be an example of, include, and/or be included in collision warning system 100 of FIG. 1 and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 901 in order to enhance an in-vehicle experience for a driver and/or a passenger.

In-vehicle computing system 900 may include one or more processors including an operating system processor 914 and an interface processor 920. Operating system processor 914 may execute an operating system on the in-vehicle computing system, and control input/output, display, playback, and other operations of the in-vehicle computing system. Interface processor 920 may interface with a vehicle control system 930 via an intra-vehicle system communication module 922.

Intra-vehicle system communication module 922 may output data to other vehicle systems 931 and vehicle control elements 961, while also receiving data input from other vehicle components and systems 931, 961, e.g. by way of vehicle control system 930. When outputting data, intra-vehicle system communication module 922 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 908 may be included in in-vehicle computing system 900 to store data such as instructions executable by processors 914 and 920 in non-volatile form. The storage device 908 may store application data to enable the in-vehicle computing system 900 to run an application for connecting to a cloud-based server and/or collecting information for transmission to the cloud-based server. The application may retrieve information gathered by vehicle systems/sensors, input devices (e.g., user interface 918), devices in communication with the in-vehicle computing system (e.g., a mobile device connected via a Bluetooth link), etc. In-vehicle computing system 900 may further include a volatile memory 916. Volatile memory 916 may be random access memory (RAM). Non-transitory storage devices, such as non-volatile storage device 908 and/or volatile memory 916, may store instructions and/or code that, when executed by a processor (e.g., operating system processor 914 and/or interface processor 920), controls the in-vehicle computing system 900 to perform one or more of the actions described in the disclosure.

A microphone 902 may be included in the in-vehicle computing system 900 to receive voice commands from a user, to measure ambient noise in the vehicle, to determine whether audio from speakers of the vehicle is tuned in accordance with an acoustic environment of the vehicle, etc. A speech processing unit 904 may process voice commands, such as the voice commands received from the microphone 902. In some embodiments, in-vehicle computing system 900 may also be able to receive voice commands and sample ambient vehicle noise using a microphone included in an audio system 932 of the vehicle.

One or more additional sensors may be included in a sensor subsystem 910 of the in-vehicle computing system 900. For example, the sensor subsystem 910 may include a camera, such as a rear view camera for assisting a user in parking the vehicle and/or a cabin camera for identifying a user (e.g., using facial recognition and/or user gestures). Sensor subsystem 910 of in-vehicle computing system 900 may communicate with and receive inputs from various vehicle sensors and may further receive user inputs. For example, the inputs received by sensor subsystem 910 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 910 alone, other sensors may communicate with both sensor subsystem 910 and vehicle control system 930, or may communicate with sensor subsystem 910 indirectly via vehicle control system 930. A navigation subsystem 911 of in-vehicle computing system 900 may generate and/or receive navigation information such as location information (e.g., via a GPS sensor and/or other sensors from sensor subsystem 910), route guidance, traffic information, point-of-interest (POI) identification, and/or provide other navigational services for the driver.

External device interface 912 of in-vehicle computing system 900 may be coupleable to and/or communicate with one or more external devices 940 located external to vehicle 901. While the external devices are illustrated as being located external to vehicle 901, it is to be understood that they may be temporarily housed in vehicle 901, such as when the user is operating the external devices while operating vehicle 901. In other words, the external devices 940 are not integral to vehicle 901. The external devices 940 may include a mobile device 942 (e.g., connected via a Bluetooth, NFC, WIFI direct, or other wireless connection) or an alternate Bluetooth-enabled device 952. Mobile device 942 may be a mobile phone, smart phone, wearable devices/sensors that may communicate with the in-vehicle computing system via wired and/or wireless communication, or other portable electronic device(s). Other external devices include external services 946. For example, the external devices may include extra-vehicular devices that are separate from and located externally to the vehicle. Still other external devices include external storage devices 954, such as solid-state drives, pen drives, USB drives, etc. External devices 940 may communicate with in-vehicle computing system 900 either wirelessly or via connectors without departing from the scope of this disclosure. For example, external devices 940 may communicate with in-vehicle computing system 900 through the external device interface 912 over network 960, a universal serial bus (USB) connection, a direct wired connection, a direct wireless connection, and/or other communication link.

The external device interface 912 may provide a communication interface to enable the in-vehicle computing system to communicate with mobile devices associated with contacts of the driver. For example, the external device interface 912 may enable phone calls to be established and/or text messages (e.g., SMS, MMS, etc.) to be sent (e.g., via a cellular communications network) to a mobile device associated with a contact of the driver. The external device interface 912 may additionally or alternatively provide a wireless communication interface to enable the in-vehicle computing system to synchronize data with one or more devices in the vehicle (e.g., the driver's mobile device) via WIFI direct, as described in more detail below.

One or more applications 944 may be operable on mobile device 942. As an example, mobile device application 944 may be operated to aggregate user data regarding interactions of the user with the mobile device. For example, mobile device application 944 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 944 to external device interface 912 over network 960. In addition, specific user data requests may be received at mobile device 942 from in-vehicle computing system 900 via the external device interface 912. The specific data requests may include requests for determining where the user is geographically located, an ambient noise level and/or music genre at the user's location, an ambient weather condition (temperature, humidity, etc.) at the user's location, etc. Mobile device application 944 may send control instructions to components (e.g., microphone, etc.) or other applications (e.g., navigational applications) of mobile device 942 to enable the requested data to be collected on the mobile device. Mobile device application 944 may then relay the collected information back to in-vehicle computing system 900.

Likewise, one or more applications 948 may be operable on external services 946. As an example, external services applications 948 may be operated to aggregate and/or analyze data from multiple data sources. For example, external services applications 948 may aggregate data from one or more social media accounts of the user, data from the in-vehicle computing system (e.g., sensor data, log files, user input, etc.), data from an interne query (e.g., weather data, POI data), etc. The collected data may be transmitted to another device and/or analyzed by the application to determine a context of the driver, vehicle, and environment and perform an action based on the context (e.g., determining a likelihood of a collision and/or outputting a warning regarding a possible collision).

Vehicle control system 930 may include controls for controlling aspects of various vehicle systems 931 involved in different in-vehicle functions. These may include, for example, controlling aspects of vehicle audio system 932 for providing audio entertainment to the vehicle occupants, aspects of climate control system 934 for meeting the cabin cooling or heating needs of the vehicle occupants, as well as aspects of telecommunication system 936 for enabling vehicle occupants to establish telecommunication linkage with others.

Audio system 932 may include one or more acoustic reproduction devices including electromagnetic transducers such as speakers. Vehicle audio system 932 may be passive or active such as by including a power amplifier. In some examples, in-vehicle computing system 900 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 934 may be configured to provide a comfortable environment within the cabin or passenger compartment of vehicle 901. Vehicle control system 930 may also include controls for adjusting the settings of various vehicle controls 961 (or vehicle system control elements) related to the engine and/or auxiliary elements within a cabin of the vehicle, such as steering wheel controls 962 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 961 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 932. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 934.

Control elements positioned on an outside of a vehicle (e.g., controls for a security system) may also be connected to computing system 900, such as via communication module 922. The control elements of the vehicle control system may be physically and permanently positioned on and/or in the vehicle for receiving user input. In addition to receiving control instructions from in-vehicle computing system 900, vehicle control system 930 may also receive input from one or more external devices 940 operated by the user, such as from mobile device 942. This allows aspects of vehicle systems 931 and vehicle controls 961 to be controlled based on user input received from the external devices 940.

In-vehicle computing system 900 may further include an antenna 906. Antenna 906 is shown as a single antenna, but may comprise one or more antennas in some embodiments. The in-vehicle computing system may obtain broadband wireless internet access via antenna 906, and may further receive broadcast signals such as radio, television, weather, traffic, and the like. The in-vehicle computing system may receive positioning signals such as GPS signals via one or more antennas 906. The in-vehicle computing system may also receive wireless commands via RF such as via antenna(s) 906 or via infrared or other means through appropriate receiving devices. In some embodiments, antenna 906 may be included as part of audio system 932 or telecommunication system 936. Additionally, antenna antenna 906 may provide AM/FM radio signals to external devices 940 (such as to mobile device 942) via external device interface 912.

One or more elements of the in-vehicle computing system 900 may be controlled by a user via user interface 918. User interface 918 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 900 and mobile device 942 via user interface 918. In addition to receiving a user's vehicle setting preferences on user interface 918, vehicle settings selected by in-vehicle control system may be displayed to a user on user interface 918. Notifications and other messages, as well as navigational assistance, may be displayed to the user on a display of the user interface. User preferences/information and/or responses to presented messages may be performed via user input to the user interface.

While various embodiments of the invention have been described, it will be apparent to those of ordinary skill in the art that many more embodiments and implementations are possible within the scope of the invention. Accordingly, the invention is not to be restricted except in light of the attached claims and their equivalents. For example, unless otherwise noted, one or more of the described methods may be performed by a suitable device and/or combination of devices, such as the collision warning system 100 described with reference to FIG. 1 and/or in-vehicle computing system 900 described with reference to FIG. 9. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for collision warning, the method comprising:
determining the presence of a second vehicle, driving behind a first vehicle in the same direction;
determining a danger value which is indicative of a potential collision of the first and the second vehicle; and
generating a warning signal which is displayed in a side or rear-view mirror of the first vehicle, if the danger value crosses a predetermined threshold.

2. The method of claim 1, wherein the warning signal includes an edge, which surrounds a reflection of the second vehicle in a side or rear-view mirror.

3. The method of claim 2, wherein the edging has a square, a rectangular, or a round shape.

4. The method of claim 2, wherein the warning signal is displayed only when the distance between the vehicles is less than a predetermined distance.

5. The method of claim 1, wherein the warning signal comprises at least one of:
a textual warning;
a visual warning; and
an acoustical warning.

6. The method of claim 5, wherein the textual warning includes a warning and/or an indication of the speed of the second vehicle.

7. The method of claim 5, wherein the visual warning includes turning on or flashing a caution light, or displaying warning signal on a display system.

8. The method of claim 5, wherein the acoustical warning includes a single tone, a tone sequence, or an announcement.

9. The method of claim 1, further comprising:
determining whether a driver of the first vehicle is looking in a direction of the side mirror or the rear-view mirror.

10. The method of claim 9, wherein a warning signal is only generated when it is determined that the driver is looking in the direction of the side mirror or the rear-view mirror.

11. The method of claim 1, wherein the danger value is dependent on at least one of:
a speed of the first vehicle;
a speed of the second vehicle;
a distance between the first and the second vehicle;
a presence of further vehicles;
road conditions of a road on which one or more of the first vehicle and the second vehicle are traversing;
a steering angle of the first vehicle;
a turn indication of the first vehicle;
a gear position of the first vehicle; and
a route that has been entered in a navigation system of the first vehicle.

12. The method of claim 1, further comprising:
determining, whether a driver of the first vehicle is initiating a passing maneuver of a third vehicle.

13. The method of claim 12, wherein the warning signal is only generated, when it is determined that the driver of the first vehicle is initiating a passing maneuver.

14. A collision warning system comprising:
a detection unit configured to determine the presence of a second vehicle, driving behind a first vehicle in the same direction;
a controller configured to determine a danger value which is indicative of a potential collision of the first and the second vehicle; and
a signal unit configured to generate a warning signal which is displayed in a side or rear-view mirror of the first vehicle, if the danger value crosses a predetermined threshold.

15. The collision warning system of claim 14, further comprising:
a monitoring unit, which is configured to determine whether the driver of the first vehicle is looking in the direction of a rear-view mirror or a side mirror.

16. The collision warning system of claim 14, wherein the signal unit is configured to generate a warning signal only when the monitoring unit detects that the driver of the first vehicle is looking in the direction of a rear-view mirror or a side mirror.

17. The collision warning system of claim 14, wherein the warning signal is one or more of a textual, visual, and an acoustical warning.

18. The collision warning system of claim 14, wherein the detection unit includes at least one of:
a camera;
a laser sensor;
a radar sensor; and
an ultrasound sensor.

19. An in-vehicle computing system for a first vehicle, the in-vehicle computing system comprising:
a sensor subsystem configured to receive signals from one or more sensors of the vehicle;
a display device;
a processor; and
a storage device storing instructions executable by the processor to:
determine a danger value that is indicative of a potential collision of the first vehicle with an object,
determine, based on one or more signals received at the sensor subsystem, whether a driver of the first vehicle is attempting to overtake a second vehicle, and
generate a warning signal that is displayed via the display device only if the danger value crosses a predetermined threshold and the driver is attempting to overtake the second vehicle.

20. The in-vehicle computing system of claim 19, wherein determining that the driver is in the overtaking mode comprises detecting a signal indicating that the driver has activated a vehicle indicator to initiate a passing maneuver.
